(19) United States
(12) Patent Application Publication
(10) Pub. No.: US 2013/0036270 A1
(43) Pub. Date: Feb. 7, 2013

(54) Data processing apparatus and method for powering down a cache

(71) Applicants: Ronald G. Dreslinski, Sterling Heights, MI (US); Ali Saidi, Austin, TX (US); Nigel Charles Paver, Austin, TX (US)

(72) Inventors: Ronald G. Dreslinski, Sterling Heights, MI (US); Ali Saidi, Austin, TX (US); Nigel Charles Paver, Austin, TX (US)

(73) Assignees: The Regents of the University of Michigan, Ann Arbor, MI (US); ARM LIMITED, Cambridge (GB)

(21) Appl. No.: 13/137,313

(22) Filed: Aug. 4, 2011

(51) Int. Cl. G06F 12/08

(52) U.S. Cl. 711/128; 711/E12.018

(57) ABSTRACT

A data processing apparatus is provided comprising a processing device, and an N-way set associative cache for access by the processing device, each way comprising a plurality of cache lines for temporarily storing data for a subset of memory addresses of a memory device, and a plurality of dirty fields, each dirty field being associated with a way portion and being set when the data stored in that way portion is dirty data. Dirty way indication circuitry is configured to generate an indication of the degree of dirty data stored in each way. Further, staged way power down circuitry is responsive to at least one predetermined condition, to power down at least a subset of the ways of the N-way set associative cache in a plurality of stages, the staged way power down circuitry being configured to reference the dirty way indication circuitry in order to seek to power down ways with less dirty data before ways with more dirty data. This approach provides a particularly quick and power efficient technique for powering down the cache in a plurality of stages.

### BACKGROUND OF THE INVENTION

1. Field of the Invention

The present invention relates to a data processing apparatus and method for powering down a cache.

2. Description of the Prior Art

A cache may be arranged to store data and/or instructions fetched from a memory so that they are subsequently readily accessible by a processing device having access to that cache, for example a processor core with which the cache may be associated. Hereafter, the term “data value” will be used to refer generically to either instructions or data, unless it is clear from the context that only a single variant (i.e. instructions or data) is being referred to.

A cache typically has a plurality of cache lines, with each cache line being able to store typically a plurality of data values. When a processing device wishes to have access (either read or write) to a data value which is not stored in the cache (referred to as a cache miss), then this typically results in a linefill process, during which a cache line's worth of data values is stored in the cache, that cache line including the data value to be accessed. Often it is necessary as an initial part of the linefill process to evict a cache line's worth of data values from the cache to make room for the new cache line of data. Should a data value in the cache line being evicted have been altered, then it is usual to ensure that the altered data value is re-written to memory, either at the time the data value is altered, or as part of the above-mentioned eviction process.

Each cache line typically has a valid flag associated therewith, and when a cache line is evicted from the cache, it is then marked as invalid. Further, when evicting a cache line, it is normal to assess whether that cache line is “clean” (i.e. whether the data values therein are already stored in memory, in which case the line is clean, or whether one or more of those data values is more up to date than the equivalent data value stored in memory, in which case that cache line is not clean, also referred to as “dirty”). A dirty flag is typically associated with each cache line to identify whether the contents of that cache line are dirty or not. If the cache line is dirty, then on eviction that cache line will be cleaned, during which process at least any data values in the cache line that are more up to date than the corresponding values in memory will be re-written to memory. Typically the entire cache line is written back to memory.

In addition to cleaning and/or invalidating cache lines in a cache during a standard eviction process resulting from a cache miss, there are other scenarios where is it generally useful to be able to clean and/or invalidate a line from a cache in order to ensure correct behaviour. One example is when employing power management techniques. For example, where a processor is about to enter a low power mode, it may be desirable to also power down an associated cache in order to save energy consumption. In that scenario, any data in the associated cache must first be saved to another level in the memory hierarchy given that that cache will lose its data when entering the low power mode.

There are many reasons why a processing device may be powered down, but one example is where the processing workload is to be transferred from that processing device to another processing device. For example, systems are currently under development where both a relatively large, high-performance, high energy consumption processor is provided to perform processing intensive tasks such as running games, etc. and in addition a relatively small, lower performance, lower energy consumption processor is provided to perform less processing intensive tasks, such as periodically checking for receipt and e-mails as a background task, etc. In such systems, wherever the processing demands allow, the relatively large processor is turned off and instead the processing is performed on the relatively small processor in order to conserve energy. Each processor may have its own local cache, and hence when switching between one processor and the other, it will be beneficial to power down the associated local cache in order to achieve further energy consumption savings.

However, the time taken to power down a cache can be significant, particularly where cache lines contain dirty data and accordingly it is necessary to perform a clean and invalidate operation in order to flush the valid and dirty data to a lower level of the memory hierarchy. To achieve the maximum energy saving from powering down a cache in such circumstances, it is beneficial if the energy consumption of the cache can be reduced as quickly as possible, and this is often difficult to achieve using current techniques.

The following articles discuss various techniques that have been developed to seek to reduce energy consumption of a cache.

The article “Limiting the Number of Dirty Cache Lines”, by Pepijn de Langen and Ben Juurlink, EDAA 2009, describes a system using two different caches, one for clean data and one for dirty data. When going into low power (standby) mode, the article describes disabling the clean data cache immediately, and then performing a writeback of the data from the dirty cache before shutting it down. However, in many systems, it is not practical to provide two such separate caches.

The article “Eager Writeback—A Technique for Improving Bandwidth Utilization,” by H.-H. S. Lee, G. S. Tyson, and M. K. Farrens, in Proceedings of ACM/IEEE International Symposium on Microarchitecture, 2000, pp. 11-21 describes a technique using any bus idle cycles to write back dirty cache lines to memory, so that on cache replacement the eviction can be avoided. This technique could also be used to reduce the time it takes to power down a cache (by providing less dirty lines), but may consume more power when a line is written back and then modified again before it is displaced.

The article “Gated-Vdd: a Circuit Technique to Reduce Leakage in Deep-Submicron Cache Memories,” by M. Powell, S.-H. Yang, B. Falsafi, K. Roy, and T. N. Vijaykumar, in Proceedings of the International Symposium on Low Power Electronics and Design, 2000, pp. 90-95 describes a technique using decay timers to disable memory cells when they have not been accessed in a long time, thereby reducing leakage power in caches.

The article “Some enhanced cache replacement policies for reducing power in mobile devices,” by Fathy, M.; Soryani, M.; Zonouz, A. E.; Asad, A.; Seyrafi, M., International Symposium on Telecommunications, 2008. IST 2008., pp. 230-234, 27-28 Aug. 2008 describes a technique which modifies the replacement policy to avoid removing dirty cache lines (avoid writebacks) in order to improve power consumption in the cache. It does however make the cache much dirtier.

The article “A highly configurable cache architecture for embedded systems,” Zhang, C.; Vahid, F.; Najjar, W., Proceedings of the 30th Annual International Symposium on Computer Architecture, 2003., pp. 136-146, 9-11 Jun. 2003, describes the setting up of a configurable cache that can change associativity depending on the workload demands. It also has provisions to reduce power consumption by turning off portions of the cache.

The article “Dynamic Way Allocation for High Performance, Low Power Caches,” Ziegler, M.; Spanberger, A.; Pai, G; Stan, M.; Skadron, K.; The International Conference on Parallel Architectures and Compilation Techniques (Work-in-Progress Session), September 2001, proposes customizing the number of ways of a cache at run time (either statically or dynamically) based on the input from the program. Programs can request entire ways to themselves (to use as scratch pads) or they can be shared. They describe a counter per column that counts how many processes are mapped to that column. There is a discussion of turning off cache ways by either writing back the data or by moving dirty data to the active portion of the cache.

It would be desirable to provide an improved technique for efficiently powering down a cache.

### SUMMARY OF THE INVENTION

Viewed from a first aspect, the present invention provides a data processing apparatus comprising: a processing device; an N-way set associative cache for access by the processing device, each way comprising a plurality of cache lines for temporarily storing data for a subset of memory addresses of a memory device, and a plurality of dirty fields, each dirty field being associated with a way portion and being set when the data stored in that way portion is dirty data, dirty data being data that has been modified in the cache without that modification being made to the equivalent data held in the memory device; dirty way indication circuitry configured to generate an indication of the degree of dirty data stored in each way; and staged way power down circuitry responsive to at least one predetermined condition, to power down at least a subset of the ways of the N-way set associative cache in a plurality of stages, the staged way power down circuitry being configured to reference the dirty way indication circuitry in order to seek to power down ways with less dirty data before ways with more dirty data.

In accordance with the present invention, dirty way indication circuitry is provided in order to generate an indication of the degree of dirty data stored in each way. When staged way power down circuitry determines that it is appropriate to power down at least a subset of the ways, it references the indications produced by the dirty way indication circuitry so as to preferentially power down the least dirty ways first. This provides a particularly quick and power efficient technique for powering down the cache in a plurality of stages.

Whilst the staged way power down circuitry is configured to preferentially power down the least dirty ways first, this does not need to occur in the absolute sense. For example, the ways can be grouped based on the indications produced by the degree way dirty checking circuitry so that all ways with similar levels of dirty data are within the same group. Within any one group, a slightly more dirty way may be powered down before a less dirty way if desired.

The dirty way indication circuitry can take a variety of forms. However, in one embodiment, the dirty way indication circuitry comprises degree way dirty checking circuitry configured, for each of a number of the ways, to generate an indication of the degree of dirty data stored in that way having regard to the dirty fields of that way.

In some embodiment, it may be sufficient to only provide the degree way dirty checking circuitry for some of the ways, for example if the apparatus is configured to only ever allocate dirty data into a subset of the ways, or if some ways could always be assumed to be very clean or very dirty based merely on the allocation policy being used. However, in one embodiment, the degree way dirty checking circuitry is provided for each way of the N-way set associative cache.

The degree way dirty checking circuitry can in some embodiments be arranged to directly reference the dirty fields of the associated way when generating the indication of the degree of dirty data stored in that way. However, in an alternative embodiment, the degree way dirty checking circuitry may maintain its own internal information that tracks with changes in the status of the various dirty fields, so that those dirty fields do not need directly referencing when producing the indication of the degree of dirty data stored in the associated way.

In an alternative embodiment, the dirty way indication circuitry is configured to infer the degree of dirty data stored in each way from information about how the ways of the cache are used, rather than referring to the dirty fields stored within each way. This could be achieved in a variety of ways. However, in one embodiment, the dirty way indication circuitry is configured to infer the degree of dirty data stored in each way based on an allocation policy used to allocate data into the ways of the cache. As a particular example, it may be the case that some ways can always be assumed to be very clean or very dirty based merely on the allocation policy being used. In such an embodiment, a precise indication of exactly how dirty each way is is not required, but instead the staged way power down circuitry powers down ways which are considered more likely to contain less dirty data before it powers down ways that are considered more likely to contain more dirty data.

A dirty field is associated with each portion of a way of the cache, and the size of the portion can vary dependent on embodiment. However, in one embodiment, each such way portion comprises one of said cache lines, such that a dirty field is provided for each cache line.

The plurality of stages that the staged way power down circuitry uses in order to power down the cache can take a variety of forms. However, in one embodiment, during at least one stage of said plurality of stages, the staged way power down circuitry is configured to power down any ways containing no dirty data. In one particular embodiment, such a stage occurs as a first stage of the power down process.

In one embodiment, during at least one stage of said plurality of stages, the staged way power down circuitry is configured to initiate a dirty data migration process, during which dirty data in at least one targeted way that is still powered is moved to at least one donor way that is still powered to seek to remove all dirty data from said at least one targeted way. The staged way power down circuitry is then configured to power down any targeted way that has no dirty data following the dirty data migration process. If desired, such a dirty data migration process can be repeated iteratively over a number of stages. In one particular embodiment, such a dirty data migration process is performed once, as a second stage of the power down process.

In one embodiment, during a final stage of said plurality of stages, the staged way power down circuitry is configured to initiate a clean operation in respect of any remaining ways that are still powered, and to then power down those remaining ways. The clean operation will ensure that all dirty data held in the relevant way is written back to a lower level of the memory hierarchy, whether that be another cache level or main memory. The cache lines in each way subjected to the clean operation will then typically be invalidated.

As a result of the above steps, the staged way power down circuitry of embodiments of the present invention can quickly begin to reduce the energy consumption of the cache when desired, whilst staging the complete power down of the cache over multiple stages. In some situations, the final stage may be omitted, such that the cache is not completely turned off, but instead the process results in a reduced size cache having less powered ways. This can be useful in a variety of situations, for example where a cache is shared by a relatively large processor and a relatively small processor, and the relatively large processor is being powered down whilst the workload is migrated to the relatively small processor.

In one embodiment, the above described dirty data migration process is not only used by the staged way power down circuitry when powering down at least part of the cache, but is also performed as a background activity, for example during a period of low activity of either the cache or the processing device. In one particular embodiment, software running on the processing device may be used to trigger such a dirty data migration process.

In one embodiment using the earlier described degree way dirty checking circuitry, the data processing apparatus further comprises cache way allocation circuitry configured to allocate new write data into the N-way set associative cache, in the event that the new write data is marked as dirty data, the cache way allocation circuitry being configured to reference the degree way dirty checking circuitry in order to preferentially allocate that new write data to a way already containing dirty data. Hence, in such embodiments, when dirty data is allocated into the cache any standard cache allocation policy is overridden, and instead allocation of that dirty data is biased towards ways already containing dirty data. This increases the chance that, when it is subsequently desired to power down at least part of the cache, there will be a number of ways that are either clean (i.e. contain no dirty data), and/or contain only a small amount of dirty data, and hence can be rendered clean by the above described dirty data migration process.

In one embodiment, in the event that there are multiple ways that can store the new write data without evicting dirty data already stored in the cache, the cache way allocation circuitry is configured to allocate the new write data to that way from amongst said multiple ways that currently stores the most dirty data having regard to said indications produced by the degree way dirty checking circuitry.

In one embodiment, said cache way allocation circuitry is configured, in the event that the new write data is marked as dirty data, to allocate that new write data to a way chosen from a predetermined subset of ways reserved for allocation of dirty data. This can be done in addition to, or as an alternative to, referencing the degree way dirty checking circuitry (and hence is applicable to embodiments that do not utilise such degree way dirty checking circuitry) in order to preferentially allocate that new write data to a way already containing dirty data. By reserving a predetermined subset of the ways for allocation of dirty data, this can reduce the amount of dirty data present elsewhere in the cache, and hence further improve efficiencies to be achieved through use of the multi-stage power down process of the earlier described embodiments of the present invention.

In one embodiment, the cache way allocation circuitry may be able to select amongst a number of different allocation policies. For example, in addition to the above described allocation policy that preferentially allocates new dirty data to a way chosen from a predetermined subset of ways, a default allocation policy may be provided that uses a standard allocation approach, for example based on mechanisms such as least recently used, round robin, etc. In such embodiments, configuration data can be used to control which allocation policy is used. This configuration data can be specified in a variety of ways, for example via a software accessible register, or via some mode prediction logic which predicts how the data processing apparatus will be using the cache (for example predicting whether a low power mode is about to be entered) and then indicates which allocation policy should be used based on that prediction.

The at least one predetermined condition that causes the staged way power down circuitry to power down at least a subset of the ways of the cache can take a variety of forms. However, in one embodiment, said at least one predetermined condition comprises an indication that the processing device is being powered down, and the staged way power down circuitry is configured to power down all of the ways of the N-way set associative cache.

In an alternative embodiment, or in addition, said at least one predetermined condition comprises a condition giving rise to an expectation that the processing device will be powered down within a predetermined timing window, and the staged way power down circuitry is configured to power down only a subset of the ways of the N-way set associative cache. The remaining ways are then left powered until the processing device is actually powered down.

Whilst the above described techniques can be used in a data processing apparatus having a single processing device coupled to the cache, it is also useful in systems using multiple processing devices. For example, in one embodiment, the data processing apparatus further comprises an additional processing device having a lower performance than said processing device, and said at least one predetermined condition comprises an indication that the processing device is being powered down in order to transfer processing to the additional processing device.

In one embodiment, the entire cache may be powered down in the above scenario. However, if the cache is shared with the additional processing device, the staged way power down circuitry may be configured to power down only a subset of the ways of the N-way set associative cache, in order to provide a reduced size cache for use by the additional processing device. This provides a particularly efficient mechanism for reducing the energy consumption of a cache, whilst sharing that cache between two differently sized processors.

In an alternative embodiment, the data processing apparatus may further comprise an additional processing device having a higher performance than said processing device, and said at least one predetermined condition comprises an indication that the processing device is being powered down in order to transfer processing to the additional processing device.

In one embodiment, said at least one predetermined condition may additionally, or alternatively, comprise a condition indicating a period of low cache utilisation, and the staged way power down circuitry may in that embodiment be configured to power down a subset of the ways of the N-way set associative cache in order to reduce energy consumption of the cache.

The degree way dirty checking circuitry associated with each cache can take a variety of forms. In one embodiment, each degree way dirty checking circuitry comprises counter circuitry for maintaining a counter which is incremented as each dirty field of the associated way is set and which is decremented as each dirty field of the associated way is cleared.

In alternative embodiment, each degree way dirty checking circuitry comprises adder circuitry for performing an addition operation in respect of the values held in each dirty field of the associated way in order to identify the number of dirty fields that are set. The adder circuitry may be arranged to continually perform this addition operation, or instead may be responsive to a trigger signal to perform the addition operation.

However, in some embodiments, an absolute indication of the total number of dirty fields set may not be required, and instead an approximation may be sufficient. Accordingly, in an alternative embodiment, each degree way dirty checking circuitry is configured to perform an approximation function based on the dirty fields of the associated way in order to provide an output indicative of the degree of dirty data stored in that associated way. An example of such an approximation function is a logical OR operation performed by an OR tree structure. Where such an approximation is sufficient, this may enable the size and complexity of the degree way dirty checking circuitry to be reduced, and may provide for a quicker output of said indication. As with the addition circuitry embodiment, in this embodiment the approximation function may be continually performed, or instead may be performed in response to a trigger signal.

Viewed from a second aspect the present invention provides a cache structure comprising: an N-way set associative cache for access by a processing device, each way comprising a plurality of cache lines for temporarily storing data for a subset of memory addresses of a memory device, and a plurality of dirty fields, each dirty field being associated with a way portion and being set when the data stored in that way portion is dirty data, dirty data being data that has been modified in the cache without that modification being made to the equivalent data held in the memory device; dirty way indication circuitry configured to generate an indication of the degree of dirty data stored in each way; and staged way power down circuitry responsive to at least one predetermined condition, to power down at least a subset of the ways of the N-way set associative cache in a plurality of stages, the staged way power down circuitry being configured to reference the dirty way indication circuitry in order to seek to power down ways with less dirty data before ways with more dirty data.

Viewed from a third aspect, the present invention provides a method of powering down an N-way set associative cache within a data processing apparatus, the N-way set associative cache being configured for access by a processing device, each way comprising a plurality of cache lines for temporarily storing data for a subset of memory addresses of a memory device, and a plurality of dirty fields, each dirty field being associated with a way portion and being set when the data stored in that way portion is dirty data, dirty data being data that has been modified in the cache without that modification being made to the equivalent data held in the memory device, the method comprising: for each way, generating an indication of the degree of dirty data stored in that way; and responsive to at least one predetermined condition, powering down at least a subset of the ways of the N-way set associative cache in a plurality of stages, the indication of the degree of dirty data stored in each way being referenced during the powering down process in order to seek to power down ways with less dirty data before ways with more dirty data.

Viewed from a fourth aspect the present invention provides a data processing apparatus comprising: processing means; an N-way set associative cache means for access by the processing means, each way comprising a plurality of cache line means for temporarily storing data for a subset of memory addresses of a memory means, and a plurality of dirty field means, each dirty field means being associated with a way portion and being set when the data stored in that way portion is dirty data, dirty data being data that has been modified in the cache means without that modification being made to the equivalent data held in the memory means; dirty way indication means for generating an indication of the degree of dirty data stored in each way; and staged way power down means, responsive to at least one predetermined condition, for powering down at least a subset of the ways of the N-way set associative cache means in a plurality of stages, the staged way power down means for referencing the dirty way indication means in order to power down ways with less dirty data before ways with more dirty data.

### BRIEF DESCRIPTION OF THE DRAWINGS

The present invention will be described further, by way of example only, with reference to embodiments thereof as illustrated in the accompanying drawings, in which:

FIG. 1 is a diagram of a system in accordance with one embodiment;

FIG. 2 schematically illustrates an N-way set associative cache;

FIG. 3 is a block diagram illustrating components provided within the N-way set associative cache in accordance with one embodiment;

FIGS. 4A to 4C illustrate different forms of degree way dirty checking circuitry that can be used in accordance with embodiments;

FIG. 5 is a flow diagram illustrating the multi-stage power down process performed by the staged way power down circuitry in accordance one embodiment;

FIG. 6 is a flow diagram illustrating in more detail the process performed to implement step 430 of FIG. 5 in accordance with one embodiment;

FIG. 7 is a flow diagram illustrating a dirty data migration process that can be performed as background activity in accordance with one embodiment;

FIG. 8 is a flow diagram illustrating how write allocation of data into the cache may be performed in accordance with one embodiment;

FIG. 9 is a diagram of a system in accordance with an alternative embodiment; and

FIG. 10 is a flow diagram illustrating a multi-stage power down process that can be performed by the staged way power down circuitry in accordance with one embodiment in order to reduce the number of active ways of the shared level 2 cache of FIG. 9 when the large processor is powered down in order to transfer workload to the small processor.

### DESCRIPTION OF EMBODIMENTS

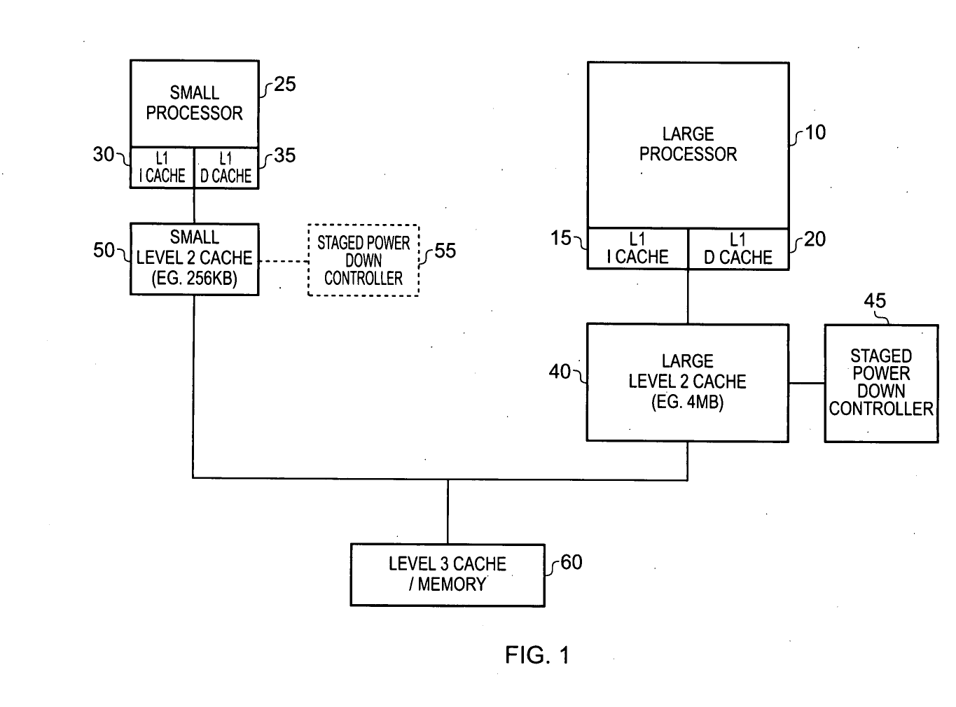

FIG. 1 is a block diagram of a data processing system in accordance with one embodiment. The system includes a relatively small, relatively low energy consumption, processor 25 (hereafter referred to as the small processor) and a relatively large, relatively high energy consumption, processor 10 (hereafter referred to as the large processor). During periods of high workload the large processor 10 is used and the small processor 25 is shut down, whilst during periods of low workload, the small processor 25 is used and the large processor 10 is shut down.

Both processors 10, 25 have their own associated level 1 (L1) instruction cache 15, 30 and L1 data cache 20, 35. In addition, both processors have their own level 2 (L2) caches, the large processor 10 having a relatively large L2 cache 40 whilst the small processor 25 has a relatively small L2 cache 50. In accordance with the illustrated embodiment, the L2 cache 40 has staged power down control circuitry 45 associated therewith, in order to power down at least a subset of the ways of the L2 cache 40 using a multi-stage power down process in accordance with embodiments of the present invention, as will be discussed in more detail later. As shown by the dotted box 55, such staged power down control circuitry may also be provided in association with the L2 cache 50 if desired.

Both L2 caches 40, 50 are then coupled to a lower level of the memory hierarchy 60, which may take the form of a level 3 (L3) cache or may take the form of main memory.

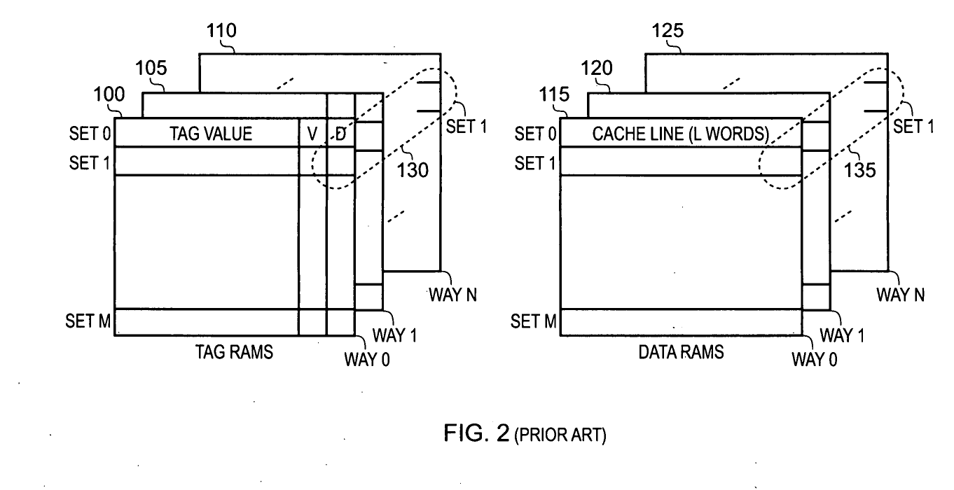

FIG. 2 illustrates the standard structure of an N-way set associative cache. A plurality of tag RAMs 100, 105, 110 are provided, one for each way of the N-way set associative cache. Similarly, a plurality of data RAMs 115, 120, 125 are provided, one for each way of the N-way set associative cache. Each data RAM includes a plurality of cache lines, each cache line being arranged to store a plurality of words that share a common tag value, the tag value being a predetermined portion of the memory address. The common tag value is then stored within the corresponding entry of the corresponding tag RAM, that entry also including a number of additional fields, such as a valid field which is set to indicate that the contents of the corresponding cache line are valid, and a dirty field which is set to indicate that the contents of the corresponding cache line are dirty. As indicated by the dashed circles 130, 135, each set of the cache comprises a single cache line from each way along with the associated entries in the tag RAMs.

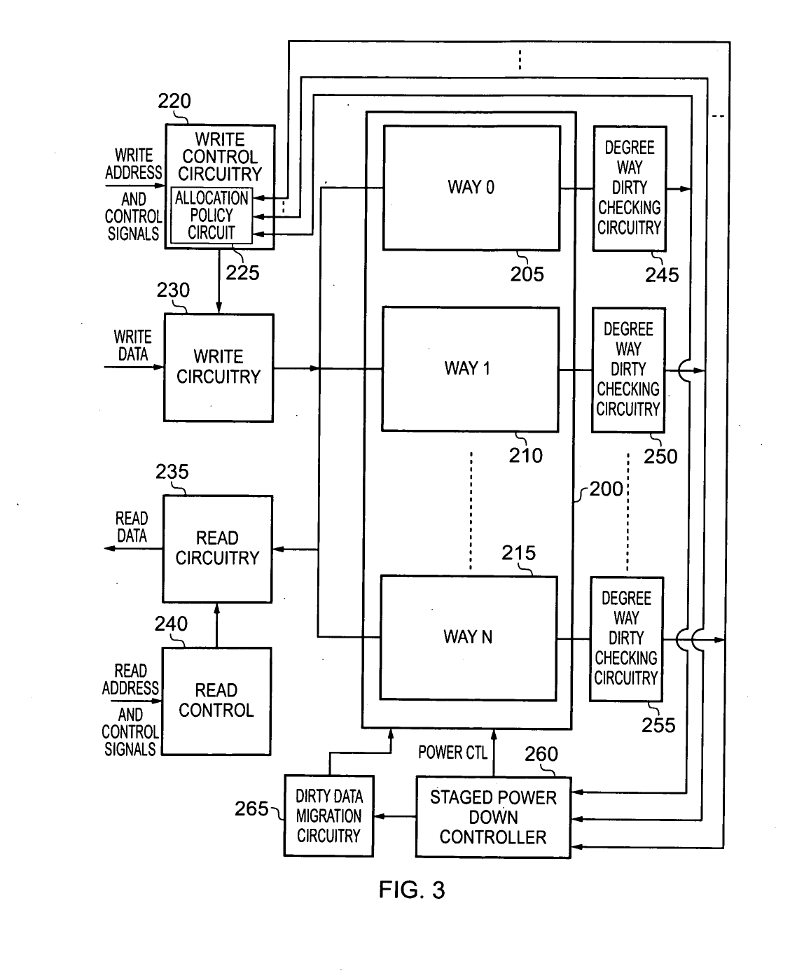

FIG. 3 is a block diagram illustrating components provided within the N-way set associative cache in accordance with one embodiment. A plurality of ways 205, 210, 215 are provided (collectively referred to as the ways 200), in this example the tag RAMs and data RAMs not being illustrated separately. Write control circuitry 220 and associated write circuitry 230 are provided to control the writing of data into the cache ways 200. In particular, on receipt of a write address and associated control signals, the write control circuitry 220 will cause the allocation policy circuit 225 to perform a cache allocation policy in order to determine the appropriate cache line in which to write the write data provided to the write circuitry 230.

Similarly, read control circuitry 240 and associated read circuitry 235 are provided to control the reading of data from the cache ways 200. In particular, on receipt of a read address and associated control signals by the read control circuitry 240, the read control circuitry will cause the read circuitry 235 to perform a lookup process within the cache ways 200 in order to determine whether the requested data is held within the cache. If it is, in relevant data will be retrieved from the relevant way and output by the read circuitry 235 to the processing device requesting the data. In the event of a cache miss, the data will instead be retrieved from a lower level of the memory hierarchy.

As shown in FIG. 3, each way is provided with degree way dirty checking circuitry 245, 250, 255, the degree way dirty checking circuitry being configured to reference the dirty fields of the associated way in order to generate an indication of the degree of dirty data stored in that way. As will be described in more detail later, the output from each degree way dirty checking circuitry can be provided to the allocation policy circuit 225 and/or to the staged power down controller 260. Additionally, although not explicitly shown in FIG. 3, the output of each degree way dirty checking circuit can also be provided to the dirty data migration circuitry 265 if dirty data migration is to be performed as a background activity, and not only when performing the staged power down process under the control of the staged power down controller 260.

Whilst for simplicity the staged power down controller 260 is shown as providing a power control signal only to the cache ways 200, in practice the staged power down controller to 60 will also issue power control signals to the other components of the cache. For example, as each individual way is powered down, the associated degree way dirty checking circuitry can also be powered down. The read and write circuits will typically include power gating mechanisms in order to reduce their power consumption during operation of the cache, and when all of the ways of the cache are powered down the staged power down controller 260 can also cause those read and write circuits to be powered down.

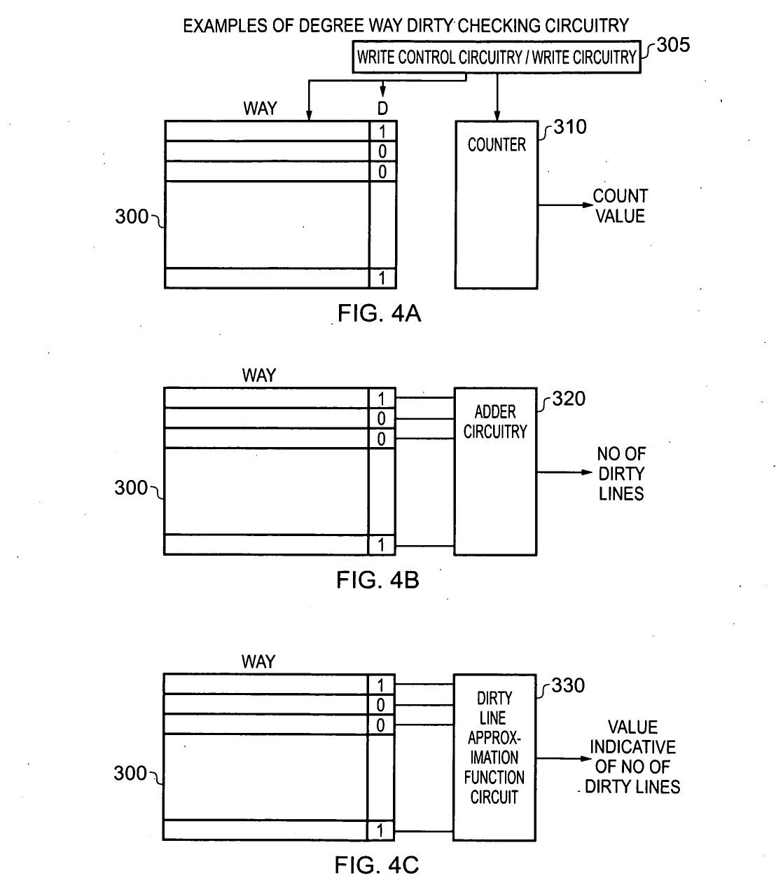

FIGS. 4A to 4C illustrate different forms of the degree way dirty checking circuitry that can be used in accordance with embodiments of the present invention. In FIG. 4A, a counter mechanism 310 is used, a counter being incremented each time a dirty bit is set and being decremented each time a dirty bit is cleared, such that at any point in time the count value maintained by the counter provides an indication of the amount of dirty data held in the corresponding way. Typically this will be achieved by arranging the counter circuit 310 to receive a control signal from the write control circuitry/write circuitry 305 each time an update in a cache line is performed, in order to cause the required increments and decrements to be performed.

In the example of FIG. 4B, an adder circuit 320 is used to form each degree way dirty checking circuit. When requested by an appropriate control signal, for example a control signal from the staged power down controller 260 or from the allocation policy circuit 225, the adder circuit performs an addition operation based on input bits received from the dirty fields in order to generate an output indicative of the number of dirty lines held within the corresponding way. In an alternative embodiment, the adder circuitry may continually produce such an output rather than being activated by a control signal.

In the example of FIG. 4C, a dirty line approximation function circuit 330 is used which is responsive to receive an appropriate control signal to apply some desired approximation function in order to generate a value indicative of the number of dirty lines held within the corresponding cache way. The approximation function can take a variety of forms. In one extreme case, it may merely produce a single bit output which is set if any of the dirty fields are set, and is clear if all of the dirty fields are clear. As with the example of FIG. 4B, in an alternative embodiment the approximation function circuit may continually produce such an output rather than being activated by a control signal.

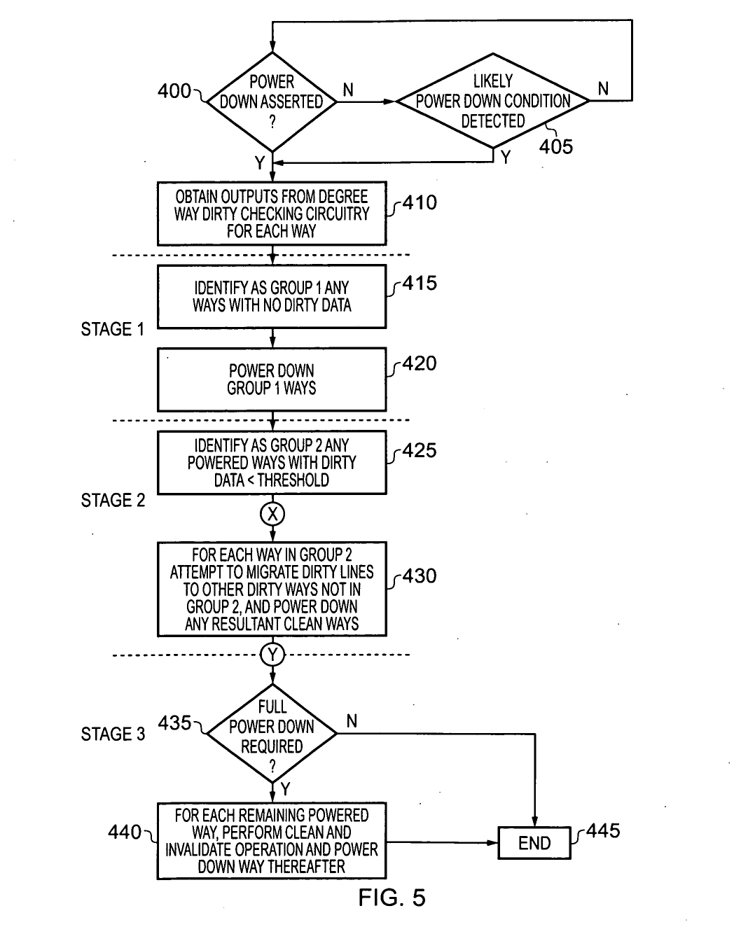

FIG. 5 is a flow diagram illustrating the steps performed by the staged power down controller 260 in accordance with one embodiment when it is desired to power down at least a subset of the ways of the N-way set associative cache. At step 400, it is determined whether a power down signal is asserted, this power down signal being asserted if the processing device coupled to the cache is being powered down. If such a power down signal is not asserted, then it is detected at step 405 whether any other condition exists which would indicate that the processing device will be powered down in the near future. Such conditions could take a variety of forms. For example, the workload could be monitored, and if the workload is consistently dropping over a period of time, this may indicate an imminent power down condition. Alternatively, various prediction mechanisms may be used to monitor the operations of the processing device and to predict therefrom the occurrence of an imminent power down condition.

If either the power down signal is asserted at step 400, or it is determined at step 405 that such a power down signal is likely in the near future, the process proceeds to step 410 where the outputs from the degree way dirty checking circuitry for each way are obtained. Thereafter, at step 415, any ways with no dirty data are identified, these ways being referred to as the group one ways. Then, at step 420 the group one ways are powered down. This process can be performed very quickly, since no clean and invalidate operation is required in respect of those ways due to the absence of any dirty data within those ways.

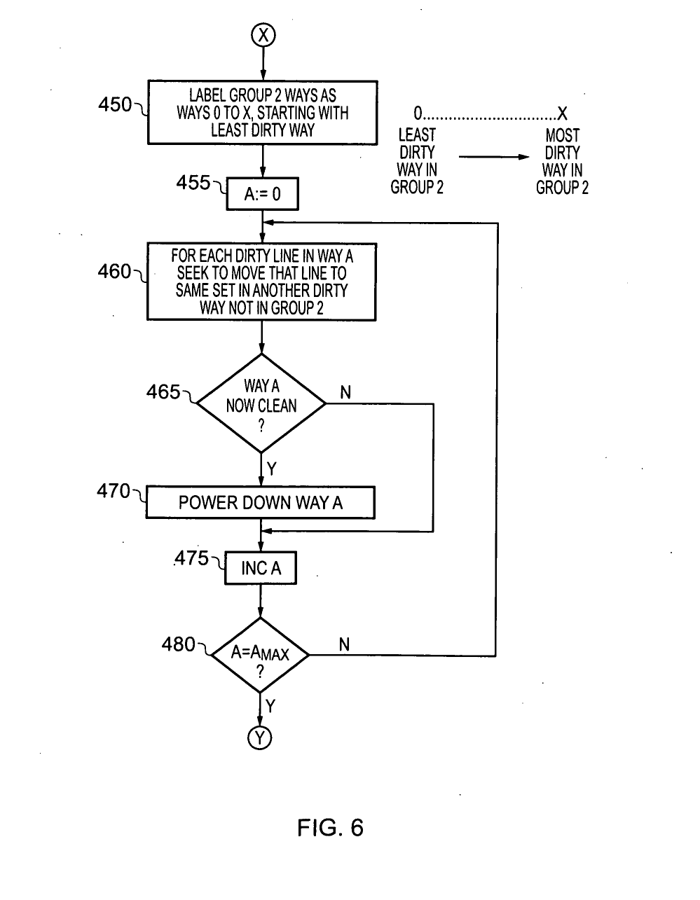

Following step 420, the process proceeds to step 425 where any powered ways with dirty data less than some predetermined threshold amount are identified, such ways being referred to as the group two ways. The predetermined threshold amount may be fixed, or may be determinable at run-time and programmed into a control register. Thereafter, at step 430, for each way in group two, the staged power down controller 260 causes the dirty data migration circuitry 265 to perform a dirty data migration process in order to attempt to migrate any dirty lines from that way to another dirty way that is not in group two. If such a process results in the way then being clean (i.e. it was possible to migrate all dirty lines to a different way), the way is then powered down. More details of the process performed during step 430 will be provided later with reference to FIG. 6.

Following step 430, the process proceeds step 435, where it is determined whether a full power down of the cache is required. In one embodiment, this will be required if the power down signal was asserted at step 400, but will not be required if the process of FIG. 5 is instead being implemented due to detection at step 405 of a likely power down in the near future. Assuming full power down is required, the process proceeds to step 440, where for each remaining powered way, a clean and invalidate operation is performed and then that way is powered down. Thereafter, the process proceeds to step 445, when the process ends.

FIG. 6 is a flow diagram illustrating in more detail the steps performed in order to implement step 430 of FIG. 5. At step 450, the group 2 ways are ordered as ways 0 to X, where way 0 is the least dirty of the group 2 ways, and way X is the most dirty of the group 2 ways. Then, at step 455, the parameter A is set equal to 0, and the process proceeds to step 460. At step 460, for each dirty line in way A, a dirty data migration process is performed in order to seek to move that line to the same set in another dirty way that is not in group 2.

Thereafter, at step 465, it is determined whether way A is now clean. If so, the process proceeds to step 470 where way A is powered down. Following step 470, or immediately following step 465 if way A is not clean, the value of A is implemented at step 475, whereafter it is determined at step 480 whether A is equal to some predetermined maximum value. If not, the process returns to step 460, whereas otherwise step 430 of FIG. 5 is considered complete.

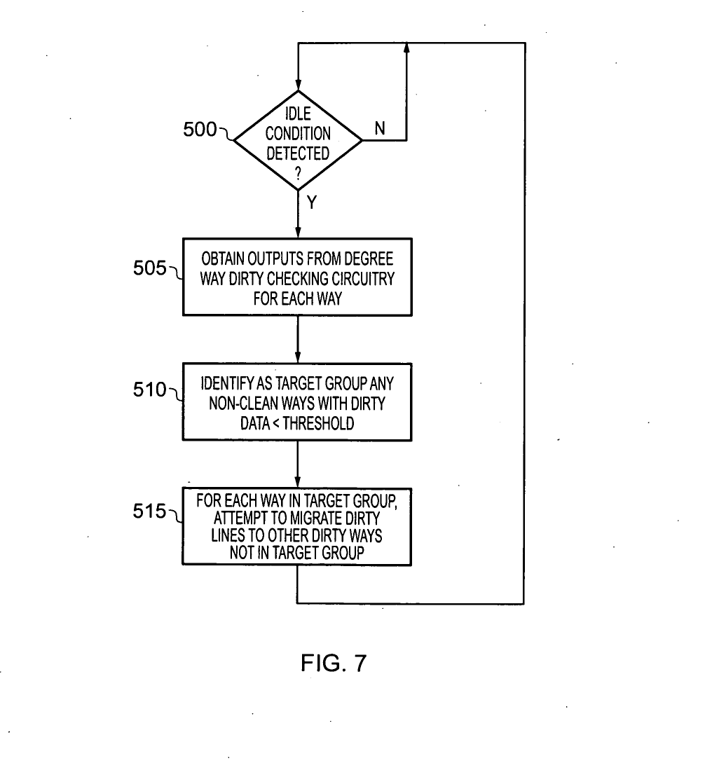

FIG. 7 is a flow diagram illustrating how the dirty data migration circuitry 265 may be used to perform a dirty data migration process is a background activity. At step 500, it is determined whether an idle condition has been detected. The idle condition can take a variety of forms, but in one embodiment is triggered by a period of low activity. Alternatively, software running on the processing device may be used to generate a signal indicating the idle condition, and hence trigger such a dirty data migration process. When the idle condition is detected, the process proceeds to step 505, where the dirty data migration circuitry 265 obtains outputs from the degree way dirty checking circuitry for each way.

Thereafter, at step 510, any non-clean ways with dirty data less than some predetermined threshold amount are identified to form a target group of ways. Then, at step 515, for each way in the target group, an attempt is made to migrate the dirty lines of that way to other dirty ways that are not in the target group (also referred to herein as the donor ways). The process then returns to step 500.

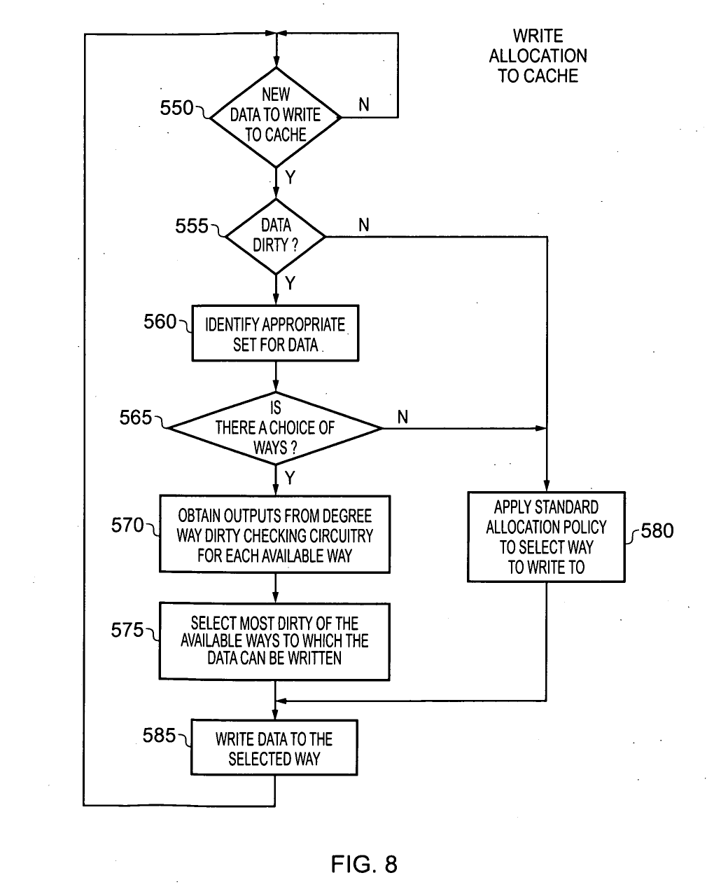

FIG. 8 is a flow diagram illustrating a write allocation operation that may be performed by the allocation policy circuit 225 of FIG. 3 in accordance with one embodiment. At step 550, it is determined whether there is any new data to be written into the cache. If so, it is then determined at step 555 whether that data is marked as dirty. Referring back to FIG. 1, this may for example be the case if the data was marked as dirty in one of the L1 caches and has now been evicted to the L2 cache.

If the data is not dirty, then the process proceeds directly to step 580, where standard allocation policy is applied in order to select an appropriate way in which to write the data. It will be understood that a variety of standard allocation policies could be used, for example the least recently used policy, a round robin policy, etc. However, if it is determined at step 555 that the data is dirty, the process proceeds to step 560 where the appropriate set for that data is identified. This is done by analysing a set portion of the memory address specified for the data.

Then, at step 565, it is determined whether there is a choice of ways in which the data can be written. In particular, it is desirable to write that data into a location that will not require an eviction operation to be performed first, i.e. a location that does not already contain dirty data. Whilst in one embodiment all of the cache ways may be candidate cache ways for receiving the dirty data, in an alternative embodiment there may be a predetermined subset of the cache ways into which it is allowed to allocate dirty data, to thereby seek to improve the probability of finding clean ways and/or ways with only a relatively small amount of dirty data when it is subsequently desired to power down at least a subset of the cache.

The choice of ways may also be restricted if, at the time the allocation process is being performed, the staged power down controller 260 is part way through the performance of the staged power down process. In particular, once the staged power down controller has identified particular ways to be powered down, the allocation policy circuit 225 can be notified in order to ensure that new dirty data to be allocated into the cache is not allocated to any of those identified ways.

If there is not a choice of ways, then the process proceeds to step 580 where the standard allocation policy is applied. However, assuming that there is a choice of ways, then the process proceeds to step 570, where the outputs from the degree way dirty checking circuitry for each available way are obtained. Then, at step 575, the most dirty of the available ways to which the data can be written is selected. Following either step 575 or step 580, the process proceeds to step 585, where the data is written to the selected way, whereafter the process returns to step 550.

Whilst the revised dirty write data allocation policy illustrated in FIG. 8 may be used at all times, in an alternative embodiment it may only be invoked when it has been decided that a power down condition is imminent, and in the absence of that condition the standard allocation policy is used for all write data allocation.

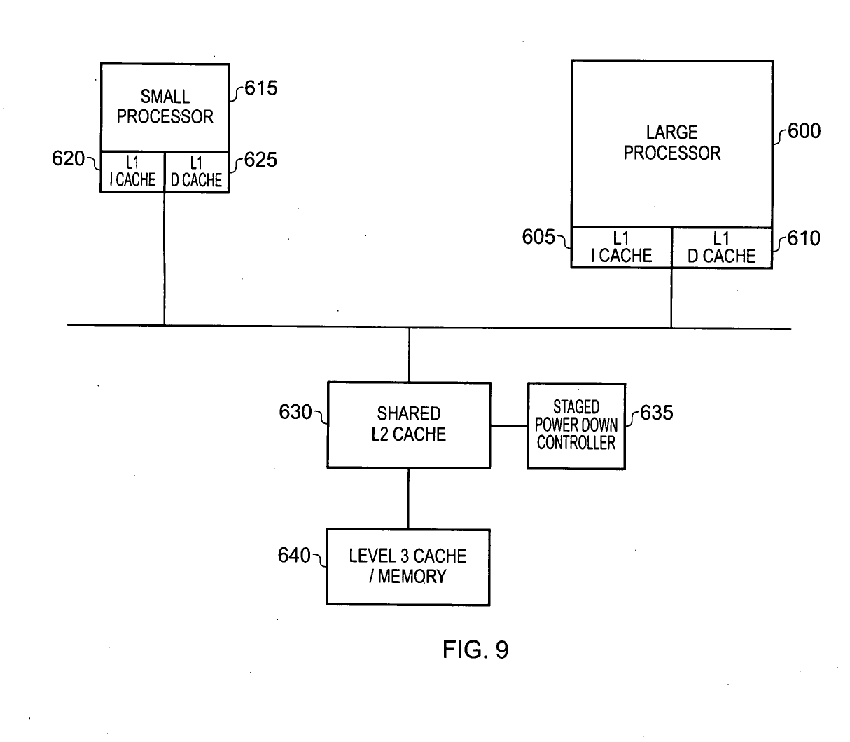

FIG. 9 is a block diagram of a data processing system in accordance with an alternative embodiment. As with the embodiment of FIG. 1, a large processor 600 is provided having its own L1 instruction cache 605 and L1 data cache 610, and also a small processor 615 is provided having its own L1 instruction cache 620 and L1 data cache 625. However, in this embodiment, the L2 cache is shared, and accordingly both processors access the shared L2 cache 630. A staged power down controller 635 is provided for the L2 cache. The L2 cache 630 is then coupled to a lower level the memory hierarchy 640, which as with the example of FIG. 1 may take the form of a L3 cache or main memory.

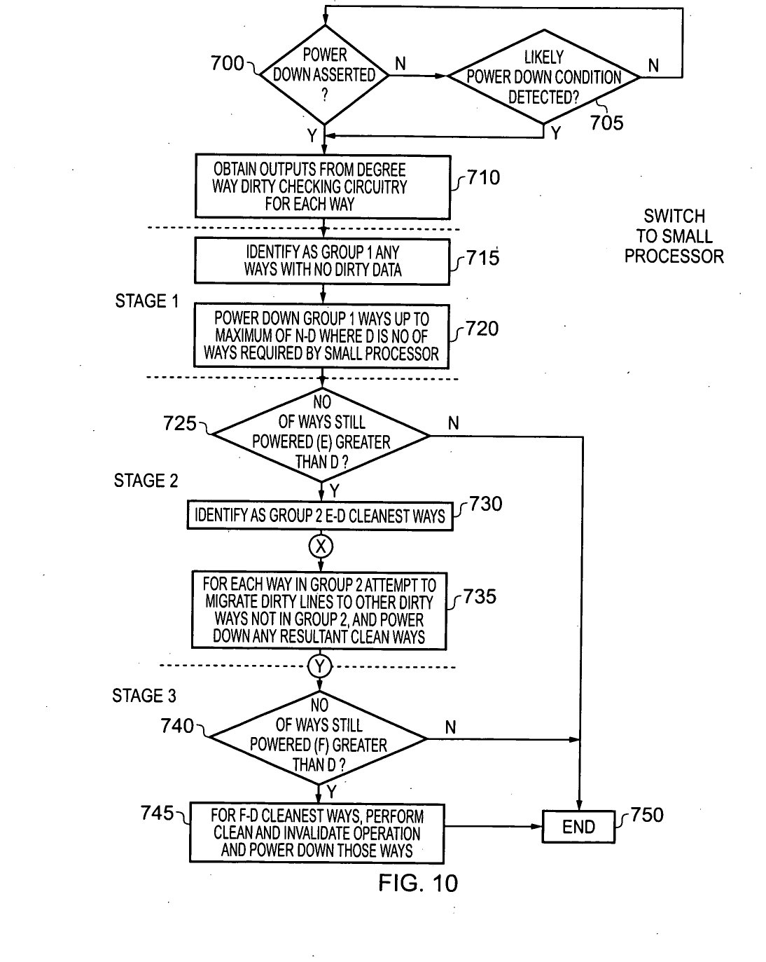

FIG. 10 is a flow diagram illustrating how the staged power down controller 635 may perform a partial power down of the L2 cache 630 over multiple stages, when the processing workload is switched from the large processor 600 to the small processor 615. Steps 700, 705, 710 and 715 correspond to steps 400, 405, 410 415 of FIG. 5, and accordingly will not be discussed further herein. Step 720 is also similar to step 420 of FIG. 5, but it is not necessarily the case that all group one ways will be powered down at step 720. In particular, assuming D is the number of ways required by the small processor 615, when powering down the group one ways at step 720, it will always be ensured that there are at least D ways that remain powered.

Following steps 720, it is determined at step 725 whether the number of ways that are still powered (E) is greater than the number of ways D required by the small processor. If not, then the process ends at step 750. However, assuming there are still more ways powered than will be needed by the small processor, the process proceeds to step 730 where the E-D cleanest ways are identified as group two. The process then proceeds to step 735, which is the same as step 430 of FIG. 5, and will accordingly not be discussed further herein.

The process then proceeds to step 740 where it is determined whether the number of ways that are still powered (F) is greater than the number of ways required by the small processor. If not, then the process ends at step 750, whereas otherwise the process proceeds to step 745, where the F-D cleanest ways are identified, a clean and invalidate operation is performed in respect of those ways, and then those ways are powered down. The process then ends at step 750.

From the above description of embodiments, it will be appreciated that those embodiments provide a mechanism for quickly and efficiently powering down at least a subset of the ways of a cache, thereby enabling a quick reduction in the energy consumption of a cache when required. The described embodiments provide a mechanism that tracks the number of dirty lines in a way, either exactly or inexactly, so that a cache way may be powered down more quickly if it does contain any dirty data. Further, in one embodiment, when new dirty data is to be written into the cache, the allocation policy selects an already dirty way (for example most dirty way) wherever possible, thereby increasing the likelihood that other ways may be powered down as fast as possible when a power down condition arises. In one embodiment, the allocation policy biases allocation of dirty data to a subset of the ways.

A dirty data migration process has also been described where an attempt is made to move dirty cache lines to the most dirty ways, with the aim of arriving at a condition where mostly clean ways can be powered down as soon as possible.

In the multi-staged power down process of one embodiment, the cleanest ways in the cache are flushed first, since those ways can be powered down most quickly, and accordingly can lead to a quick decrease in the energy consumption of the cache.

In one embodiment, the cache size is reduced by powering down ways during periods of low cache utilisation based on the ways which are the cleanest, thereby giving rise to an energy consumption reduction in the cache.

In one embodiment, a mechanism is provided for prohibiting the cache from dirtying a line in a given way once that way has been identified by the staged power down controller as a way to be powered down.

In one embodiment, the dirty data migration process is also performed during periods of low activity, or periodically, in order to consolidate dirty data into a smaller subset of the ways.

Through use of the techniques of the above described embodiments, a multi-staged power down mechanism is used in combination with a revised allocation policy in order to allow for a faster flushing of at least a subset of the ways of the cache, and a reduced power consumption due to the faster flushing. Whilst there are many applications for such a technique, the technique is particularly beneficial when used within a system containing both a relatively large processor and a relatively small processor, with a processing workload being switched between the two processors depending on the size or processing intensity of that workload. In particular, by using the above described techniques, the power consumption of the cache(s) can be reduced during a switch between the two processors. In one particular embodiment, a shared cache can be resized as required during the switch process, so that for example when the smaller processor is operating, a reduced number of ways may be powered. Such an approach could be especially useful with 3D stacking, since a low power processor core could be placed geographically very close to the L2 cache used by a larger processor core, and ways could be powered down to save power.

Although particular embodiments have been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. A data processing apparatus comprising:
a processing device;
an N-way set associative cache for access by the processing device, each way comprising a plurality of cache lines for temporarily storing data for a subset of memory addresses of a memory device, and a plurality of dirty fields, each dirty field being associated with a way portion and being set when the data stored in that way portion is dirty data, dirty data being data that has been modified in the cache without that modification being made to the equivalent data held in the memory device;
dirty way indication circuitry configured to generate an indication of the degree of dirty data stored in each way; and
staged way power down circuitry responsive to at least one predetermined condition, to power down at least a subset of the ways of the N-way set associative cache in a plurality of stages, the staged way power down circuitry being configured to reference the dirty way indication circuitry in order to seek to power down ways with less dirty data before ways with more dirty data.

2. A data processing apparatus as claimed in claim 1, wherein the dirty way indication circuitry comprises degree way dirty checking circuitry configured, for each of a number of the ways, to generate an indication of the degree of dirty data stored in that way having regard to the dirty fields of that way.

3. A data processing apparatus as claimed in claim 1, wherein the dirty way indication circuitry is configured to infer the degree of dirty data stored in each way from information about how the ways of the cache are used.

4. A data processing apparatus as claimed in claim 3, wherein the dirty way indication circuitry is configured to infer the degree of dirty data stored in each way based on an allocation policy used to allocate data into the ways of the cache.

5. A data processing apparatus as claimed in claim 1, wherein each said way portion comprises one of said cache lines, such that a dirty field is provided for each cache line.

6. A data processing apparatus as claimed in claim 1, wherein during at least one stage of said plurality of stages, the staged way power down circuitry is configured to power down any ways containing no dirty data.

7. A data processing apparatus as claimed in claim 1, wherein:
during at least one stage of said plurality of stages, the staged way power down circuitry is configured to initiate a dirty data migration process, during which dirty data in at least one targeted way that is still powered is moved to at least one donor way that is still powered to seek to remove all dirty data from said at least one targeted way; and
the staged way power down circuitry is configured to power down any targeted way that has no dirty data following the dirty data migration process.

8. A data processing apparatus as claimed in claim 1, wherein:
during a final stage of said plurality of stages, the staged way power down circuitry is configured to initiate a clean operation in respect of any remaining ways that are still powered, and to then power down those remaining ways.

9. A data processing apparatus as claimed in claim 2, further comprising:
cache way allocation circuitry configured to allocate new write data into the N-way set associative cache, in the event that the new write data is marked as dirty data, the cache way allocation circuitry being configured to reference the degree way dirty checking circuitry in order to preferentially allocate that new write data to a way already containing dirty data.

10. A data processing apparatus as claimed in claim 9, wherein in the event that there are multiple ways that can store the new write data without evicting dirty data already stored in the cache, the cache way allocation circuitry is configured to allocate the new write data to that way from amongst said multiple ways that currently stores the most dirty data having regard to said indications produced by the degree way dirty checking circuitry.

11. A data processing apparatus as claimed in claim 9, wherein said cache way allocation circuitry is configured, in the event that the new write data is marked as dirty data, to allocate that new write data to a way chosen from a predetermined subset of ways reserved for allocation of dirty data.

12. A data processing apparatus as claimed in claim 1, further comprising:
cache way allocation circuitry configured to allocate new write data into the N-way set associative cache, in the event that the new write data is marked as dirty data, the cache way allocation circuitry being configured to employ an allocation policy that allocates that new write data to a way chosen from a predetermined subset of ways reserved for allocation of dirty data.

13. A data processing apparatus as claimed in claim 12, wherein the cache way allocation circuitry is configured to select between said allocation policy and a default allocation policy based on configuration data.

14. A data processing apparatus as claimed in claim 1, further comprising:
dirty data migration circuitry, responsive to a migration condition, to initiate a dirty data migration process, during which dirty data in at least one targeted way is moved to at least one donor way to seek to remove all dirty data from said at least one targeted way.

15. A data processing apparatus as claimed in claim 14, wherein said migration condition is triggered by a period of low activity.

16. A data processing apparatus as claimed in claim 14, wherein said migration condition is triggered by a signal asserted from said staged way power down circuitry whilst powering down at least a subset of the ways of the N-way set associative cache.

17. A data processing apparatus as claimed in claim 1, wherein said at least one predetermined condition comprises an indication that the processing device is being powered down, and the staged way power down circuitry is configured to power down all of the ways of the N-way set associative cache.

18. A data processing apparatus as claimed in claim 1, wherein said at least one predetermined condition comprises a condition giving rise to an expectation that the processing device will be powered down within a predetermined timing window, and the staged way power down circuitry is configured to power down only a subset of the ways of the N-way set associative cache.

19. A data processing apparatus as claimed in claim 1, further comprising:
an additional processing device having a lower performance than said processing device;
said at least one predetermined condition comprising an indication that the processing device is being powered down in order to transfer processing to the additional processing device.

20. A data processing apparatus as claimed in claim 19, wherein said N-way set associative cache is shared with said additional processing device, and the staged way power down circuitry is configured to power down only a subset of the ways of the N-way set associative cache, in order to provide a reduced size cache for use by the additional processing device.

21. A data processing apparatus as claimed in claim 1, further comprising:
an additional processing device having a higher performance than said processing device;
said at least one predetermined condition comprising an indication that the processing device is being powered down in order to transfer processing to the additional processing device.

22. A data processing apparatus as claimed in claim 1, wherein said at least one predetermined condition comprises a condition indicating a period of low cache utilisation, and the staged way power down circuitry is configured to power down a subset of the ways of the N-way set associative cache in order to reduce energy consumption of the cache.

23. A data processing apparatus as claimed in claim 2, wherein each degree way dirty checking circuitry comprises counter circuitry for maintaining a counter which is incremented as each dirty field of the associated way is set and which is decremented as each dirty field of the associated way is cleared.

24. A data processing apparatus as claimed in claim 2, wherein each degree way dirty checking circuitry comprises adder circuitry for performing an addition operation in respect of the values held in each dirty field of the associated way in order to identify the number of dirty fields that are set.

25. A data processing apparatus as claimed in claim 2, wherein each degree way dirty checking circuitry is configured to perform an approximation function based on the dirty fields of the associated way in order to provide an output indicative of the degree of dirty data stored in that associated way.

26. A data processing apparatus as claimed in claim 2, wherein said degree way dirty checking circuitry is provided for each way of the N-way set associative cache.

27. A cache structure comprising:
an N-way set associative cache for access by a processing device, each way comprising a plurality of cache lines for temporarily storing data for a subset of memory addresses of a memory device, and a plurality of dirty fields, each dirty field being associated with a way portion and being set when the data stored in that way portion is dirty data, dirty data being data that has been modified in the cache without that modification being made to the equivalent data held in the memory device;
dirty way indication circuitry configured to generate an indication of the degree of dirty data stored in each way; and
staged way power down circuitry responsive to at least one predetermined condition, to power down at least a subset of the ways of the N-way set associative cache in a plurality of stages, the staged way power down circuitry being configured to reference the dirty way indication circuitry in order to seek to power down ways with less dirty data before ways with more dirty data.

28. A method of powering down an N-way set associative cache within a data processing apparatus, the N-way set associative cache being configured for access by a processing device, each way comprising a plurality of cache lines for temporarily storing data for a subset of memory addresses of a memory device, and a plurality of dirty fields, each dirty field being associated with a way portion and being set when the data stored in that way portion is dirty data, dirty data being data that has been modified in the cache without that modification being made to the equivalent data held in the memory device, the method comprising:
for each way, generating an indication of the degree of dirty data stored in that way; and
responsive to at least one predetermined condition, powering down at least a subset of the ways of the N-way set associative cache in a plurality of stages, the indication of the degree of dirty data stored in each way being referenced during the powering down process in order to seek to power down ways with less dirty data before ways with more dirty data.

29. A data processing apparatus comprising:
processing means;
an N-way set associative cache means for access by the processing means, each way comprising a plurality of cache line means for temporarily storing data for a subset of memory addresses of a memory means, and a plurality of dirty field means, each dirty field means being associated with a way portion and being set when the data stored in that way portion is dirty data, dirty data being data that has been modified in the cache means without that modification being made to the equivalent data held in the memory means;
dirty way indication means for generating an indication of the degree of dirty data stored in each way; and
staged way power down means, responsive to at least one predetermined condition, for powering down at least a subset of the ways of the N-way set associative cache means in a plurality of stages, the staged way power down means for referencing the dirty way indication means in order to power down ways with less dirty data before ways with more dirty data.
